(19) United States
(12) Patent Application Publication
(10) Pub. No.: US 2013/0249810 A1
(43) Pub. Date: Sep. 26, 2013

(54) TEXT ENTRY MODE SELECTION

(71) Applicant: Gilead Almosnino, Redmond, WA (US)

(72) Inventor: Gilead Almosnino, Redmond, WA (US)

(73) Assignee: Microsoft Corporation, Redmond, WA (US)

(21) Appl. No.: 13/427,496

(22) Filed: Mar. 22, 2012

(51) Int. Cl. G06F 3/041; G09G 5/00

(52) U.S. Cl. 345/173; 345/156

(57) ABSTRACT

Some implementations provide techniques and arrangements for text entry mode selection. For instance, some examples display a text entry area in a graphical user interface. The text entry area may have a plurality of activation areas, with each activation area corresponding to a respective text entry mode of the text entry area. Upon receiving an input in one of the activation areas, the text entry area may be activated in the text entry mode corresponding to the activation area in which the input is received.

### BACKGROUND

Users who work with languages such as Arabic and Hebrew require the ability to input text from right to left. Often, users who work with Arabic or Hebrew also require the ability to input text from left to right when using languages such are English. Typically, this type of support is enabled by allowing the user to adjust the text entry direction via a keyboard shortcut, user interface (UI) shortcut, and/or automatic determination based on the keyboard language and or input character analysis. In the case of keyboard shortcuts or UI shortcuts, once the user has activated (i.e. selected) the text entry field, input direction adjustment is manipulated using a keyboard shortcut such as a Ctrl+Shift key combination. Similar functionality may also be made available via graphical user interface (GUI) commands. In systems using automatic determinations based on the keyboard language and or input character analysis, applications or the operating system automatically change the text entry direction by referencing the current state of the input language and/or analyzing the first few characters inputted by the user and then setting the text entry direction automatically.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations provide techniques and arrangements for text entry mode selection. For example, some display a text entry area in a graphical user interface. The text entry area may have a plurality of activation areas, with each activation area corresponding to a respective text entry mode of the text entry area. Upon receiving an input in one of the activation areas, the text entry area may be activated in the text entry mode corresponding to the activation area in which the input is received.

### BRIEF DESCRIPTION OF THE DRAWINGS

The Detailed Description is described with reference to the accompanying figures. The use of the same reference numbers in different figures indicates similar or identical items.

FIG. 1 illustrates an example system according to some implementations.

FIG. 2 illustrates an example process flow according to some implementations.

FIG. 3 illustrates an example system according to some implementations.

FIG. 4 illustrates an example display according to some implementations.

FIG. 5 illustrates an example system in which some implementations may operate.

### DETAIL DESCRIPTION

### Overview

This disclosure includes techniques and arrangements for text entry mode selection. In some implementations, the system uses a relative location of an input (e.g. a touch, gesture or mouse click, etc.) that activates a text entry area displayed in a GUI to activate the text entry area with a particular text entry mode of a plurality of text entry modes. For example, in a system with two text entry modes, if the activating input is located on the left side of the text entry area, a first text entry mode is activated and if the activating input is located on the right side of the text entry area, a second text entry mode is activated. Text entry modes can include various types of modes including but not limited to text input direction (e.g. left to right (English) or right to left (Arabic or Hebrew), text input language, keyboard language, selection of an on-screen keyboard for text entry, which hardware input device to use for text entry, and so forth. Although the discussion herein may describe implementations in which one of two text entry modes is activated, implementations are not so limited and may include more than two entry modes.

The text entry mode selection functionality described herein may be implemented at various levels in the software and hardware of computing systems. Such levels include the Operating System (OS) level, such as in the OS with or without application support, the application level, either separate from OS (i.e. stand-alone) or as a plugin to the OS or a plug-in to another application and so forth. Further, the text entry mode selection functionality may be implemented universally for all text entry areas in all applications, such as in OS only implementations, or the functionality may only be active in select text entry areas, either in specific programs, classes of programs, specified text entry areas, classes of text entry areas, and so forth. Moreover, some implementations may allow a user to set various parameters of the text entry mode selection functionality such as, the class of programs or text entry areas that implement the functionality, the text entry modes to be used for the functionality and so forth.

It should also be noted that, for readability, interactions between modules may be described herein as signals or commands, but it would be understood by one of ordinary skill in the art that such interactions may be implemented in various ways, such as by function calls between various program modules.

### Example Implementations

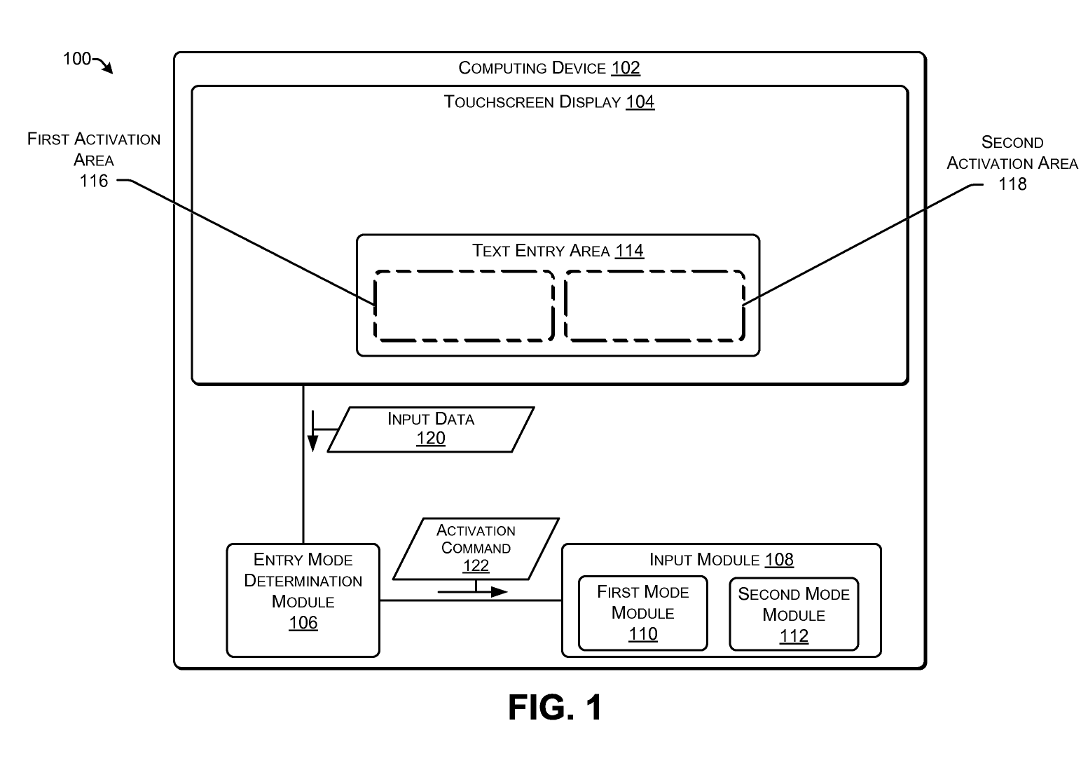

FIG. 1 illustrates an example framework of a system 100 according to some implementations. System 100 includes a computing device 102 that is illustrated as a logical system made up of a touchscreen display 104, an input determination module 106 and an input module 108. The input module 108 includes a first mode module 110 and a second mode module 112. The touch screen display displays a text entry area 114 which is activated by a touch input. The text entry area 114 includes two activation areas, a first activation area 116 and a second activation area 118 which correspond to a first entry mode of the first mode module 110 and a second entry mode of the second mode module 112, respectively.

While the computing device 102 is illustrated as including a touchscreen display and two separate modules, implementations are not so limited and may be implemented as a single module or any number of modules and hardware components. As such, it should be noted that the logical arrangements illustrated herein may be implemented as one or several components of hardware each configured to perform one or more functions, may be implemented in software or firmware where one or more programs are used to perform the different functions, or may be a combination of hardware, firmware, and/or software. For purposes of discussion, the modules described herein will be discussed as a set of software routines stored in a computer readable storage medium.

Also, for ease of discussion and comprehension, FIG. 1 is illustrated as including a touchscreen display 104 for which activation of the first or second entry mode is accomplished by a touch selection in the corresponding activation areas when the text entry area 114 is activated. However, implementations are not so limited. For example, in some implementations, the computing device 102 may include a mouse and keyboard and the selection of text entry mode is done by clicking the activation area of the text entry area 114 corresponding to the desired text entry mode (e.g. clicking a mouse button while a mouse cursor is positioned over the activation area corresponding to the desired text entry mode). In other implementations including a mouse and keyboard, the text entry mode may have a default setting with a combination input, such as a Ctrl+click of an activation area, triggering the operation of the entry mode determination module 106 to select alternative text entry modes. In other implementations, the text entry area may not include separate activation areas for each mode. Rather, such implementations may determine the text entry mode based on different combination inputs used to activate the text entry area, e.g. Shift+click for a first entry mode and Ctrl+click for a second entry mode. Still other implementations may involve other types of input. For example, in a system with voice input controls, different voice commands could be used to activate the text entry area in different or alternative text entry modes. These and other variations on the implementation of the particulars of the activation command would be apparent to one of ordinary skill in the art in view of the disclosure herein.

In some examples, a touch selection is detected by the touchscreen display 104 in the text entry area 114. The touch screen display sends input data 120 to the entry mode determination module 106. The input data 120 includes at least an indication of the location on the touchscreen of the touch selection, e.g. whether the touch selection was located in the first activation area 116 or the second activation area 118 or coordinates of the position on the touchscreen of the touch selection.

The entry mode determination module 106 receives the input data 120 and determines which entry mode to activate based on the indication of the location of the touch selection on the touchscreen included in the input data 120. The entry mode determination module 106 then outputs an activation command 122 to activate the first mode module 110 or second mode module 112 of the input module 108 according to the determined entry mode.

The input module 108 receives the activation command 122 that includes the indication of the determined mode. The input module 108 then activates the first mode module 110 or the second mode module 112 in accordance with the activation command 122. Thus, the text entry area is then activated and the computing device 102 is ready to accept input according to the entry mode indicated by the touch selection.

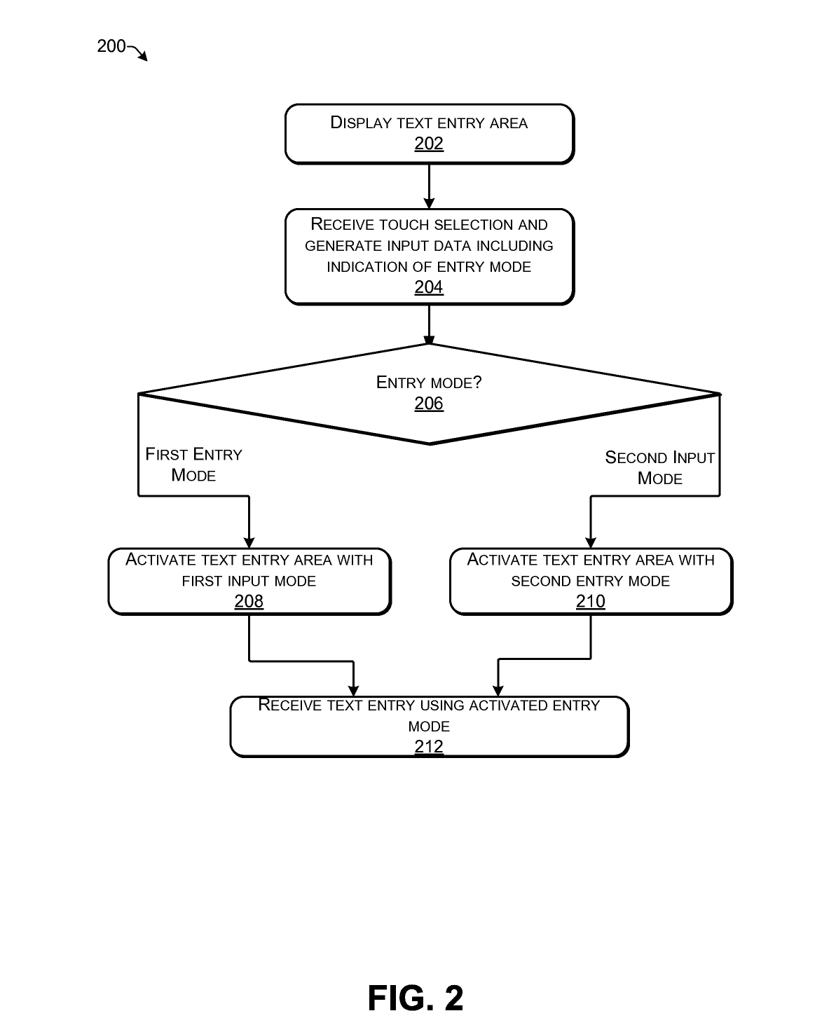

FIG. 2 illustrates an example process flow 200 according to some implementations. In the flow diagrams of FIG. 2, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 200 is described with reference to the system 100, described above, although other models, frameworks, systems and environments may implement the illustrated process.

At block 202, the computing device 102 displays the text entry area 114 on the touchscreen display 104.

At block 204, a touch selection is detected by the touchscreen display 104 and touchscreen display 104 generates input data 120 that includes at least an indication of the location on the touchscreen of the touch selection, e.g. whether the touch selection was located in the first activation area or the second activation area or coordinates on the touchscreen of the touch selection. As stated above, in other implementations, a combination input or other input that has the effect of activating the text entry area 114 may be used as alternative or in combination with separate activation areas for each entry mode. The input data 120 is then sent to the entry mode determination module 106.

At block 206, the entry mode determination module 106 receives the input data 120 and determines which entry mode is to be activated. In particular, if the touch selection is detected in the first activation area 116, the entry mode determination module 106 determines that the first mode module 110 is to be activated and outputs an appropriate activation command 122 to activate the first mode module 110. The process flow then continues to block 208. Alternatively, if the touch selection is detected in the second activation area 118, the entry mode determination module 106 determines that the second mode module 112 is to be activated and outputs an appropriate activation command 122 to activate the second mode module 112. The process flow then continues to block 210.

At block 208, input module 108 receives the activation command 122 that indicates that the first mode module 110 is to be activated. The input module 108 then activates the first mode module 110. The flow then proceeds to block 212.

At block 210, input module 108 receives the activation command 122 that indicates that the second mode module 112 is to be activated. The input module 108 then activates the second mode module 112. The flow then proceeds to block 212.

At block 212, the first mode module 110 or second mode module 112 has been activated in accordance with the touch selection and the computing device 102 receives text entry using the entry mode of the activated mode module.

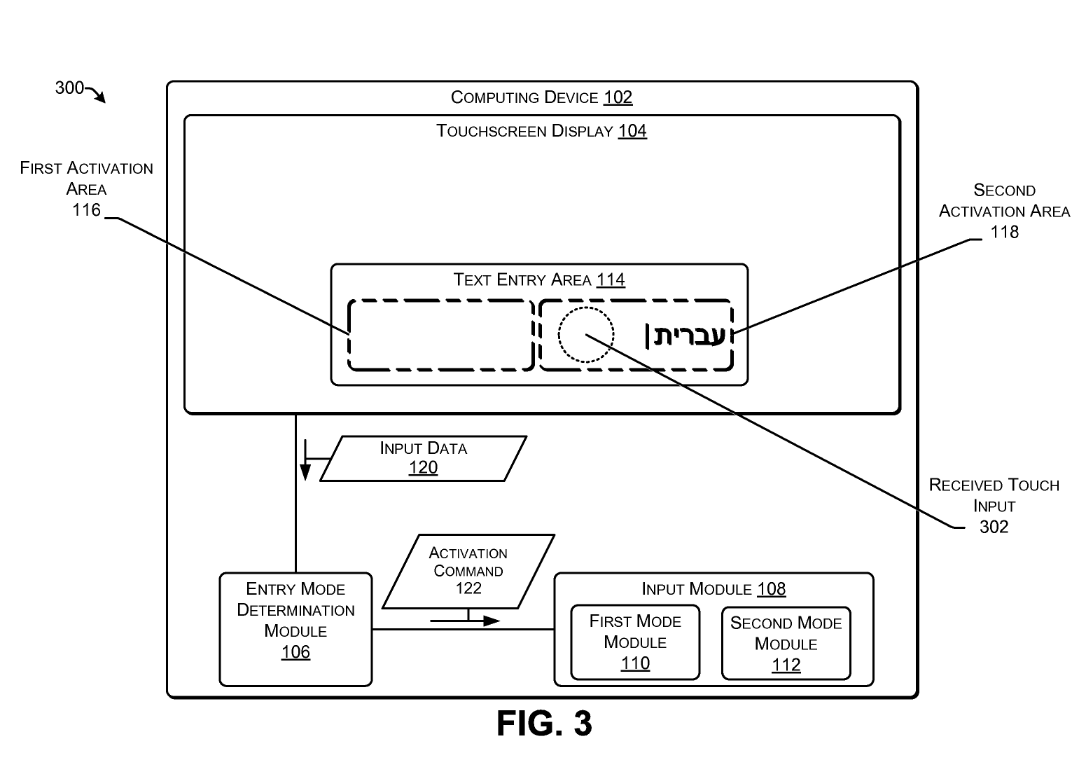

FIG. 3 illustrates an example system 300 according to some implementations. In the particular implementation illustrated in FIG. 3, the computing device 102 is used such that the text entry direction is determined from the location of the text entry area activation input. Specifically, an activation input detected on the left side of the text entry area 114 (i.e. within the first activation area 116) activates the text entry area 114 in a first mode in which text is entered left to right. This may also be associated with a particular text entry language (e.g. English) such that text is entered left to right and spell check, grammar check, word suggestion/completion, and the like are performed in the English language. Similarly, if the activation input is detected on the right side of the text entry area 114 (i.e. within the second activation area 118), the text entry area 114 is activated in a second mode in which text is entered right to left. The second entry mode may also be associated with a different text entry language (e.g. Arabic or Hebrew) such that text is entered right-to-left and spell check, grammar check, word suggestion/completion, and the like are performed in Arabic or Hebrew. As such, in the illustrated example shown in FIG. 3, because the received touch selection 302 is located on the right side of text entry area 114, the second mode module 112 for the second text entry mode is activated and text entry is accepted in the right to left direction in Hebrew.

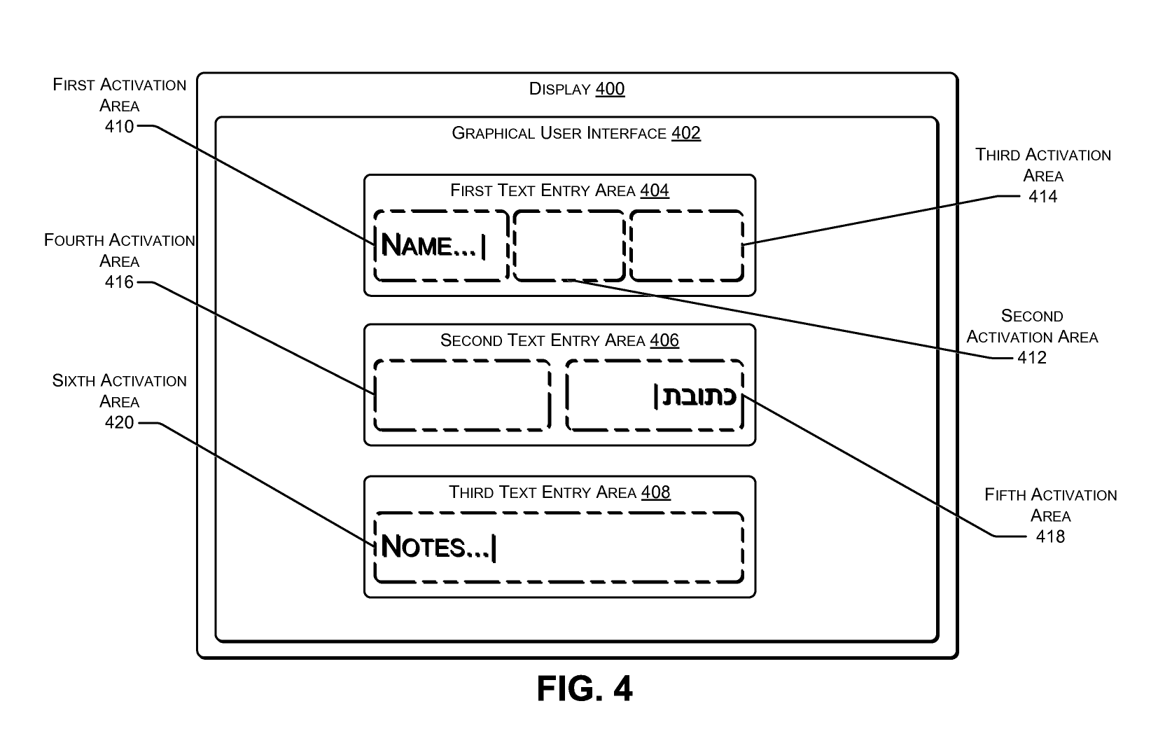

FIG. 4 illustrates another example according to some implementations including display 400, which may be a touchscreen display, a computer monitor, or other type of display. In the particular implementation illustrated in FIG. 4, the display 400 displays a graphical user interface 402 that includes a first text entry area 404, a second text entry area 406, and a third text entry area 408. For example, the graphical user interface 402 may be a form that includes multiple boxes that are to be filled out (i.e. text entry areas 404, 406 and 408). As illustrated in the example shown in FIG. 4, each of the text entry areas may have a different set of available text entry modes. As an example, consider a form that is intended to be usable for entering information for residents in an area that includes people with English, Arabic and Hebrew names and English and Hebrew addresses. In this example, first text entry area 404 could correspond to the form's name box, second text entry area 406 could correspond to the form's address box, and third text entry area 408 could correspond to an English only box of the form that is used for notes or other data. The first text entry area 404 has three activation areas, 1) a first activation area 410 that corresponds to an entry mode with a left to right direction using the English language, 2) a second activation area 412 that corresponds to an entry mode with a right to left direction using the Arabic language, and 3) a third activation area 410 that corresponds to an entry mode with a right to left direction using the Hebrew language. Similarly, the second text entry area 406 has two activation areas, 1) a fourth activation area 416 that corresponds to an entry mode with a left to right direction using the English language and 2) a fifth activation area 418 that corresponds to an entry mode with a right to left direction using the Hebrew language. Finally, third text entry area 408 includes a sixth activation area 420 that corresponds to an entry mode with a left to right direction using the English language. In the particular example illustrated in FIG. 4, the first activation area 410 has been used to activate the first text entry area 404 in an entry mode with a left to right direction using the English language to enter an English language name, the fifth activation area 418 has been used to activate the second text entry area 406 in an entry mode with a right to left direction using the Hebrew language to enter a Hebrew language address, and the sixth activation area 420 has been used to activate the third text entry area 408 in an entry mode with a left to right direction using the English language to enter English language notes.

While several examples have been illustrated herein for discussion purposes, numerous other configurations may be used and thus implementations herein are not limited to any particular configuration or arrangement. For example, the discussion herein refers to signals being output and received by particular components or modules system. This should not be taken as a limitation as such communication need not be direct and the particular components or module need not necessarily be a single functional unit. For example, the entry mode determination module 106 and input module 108 are discussed as separate logical components of the system which carry out separate step functions and communicate with each other. This is not to be taken as limiting implementations to only those in which the modules directly send and receive signals from one another. The signals could instead be relayed by a separate module upon receipt of the signal. Further, the modules may be combined or the functionality may be separated amongst modules in various manners not limited to those discussed above. Other variations in the logical and practical structure and framework of various implementations would be apparent to one of ordinary skill in the art in view of the disclosure provided herein.

The processes described herein are only examples provided for discussion purposes. Numerous other variations will be apparent to those of skill in the art in light of the disclosure herein. Further, while the disclosure herein sets forth several examples of suitable frameworks, architectures and environments for executing the techniques and processes herein, implementations herein are not limited to the particular examples shown and discussed. The processes illustrated herein are shown as a collection of operations in a logical flow graph, which represents a sequence of operations, some or all of which can be implemented in hardware, software or a combination thereof. In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation. Any number of the described blocks can be combined in any order and/or in parallel to implement the process, and not all of the blocks need be executed.

### Example Computing Device and Environment

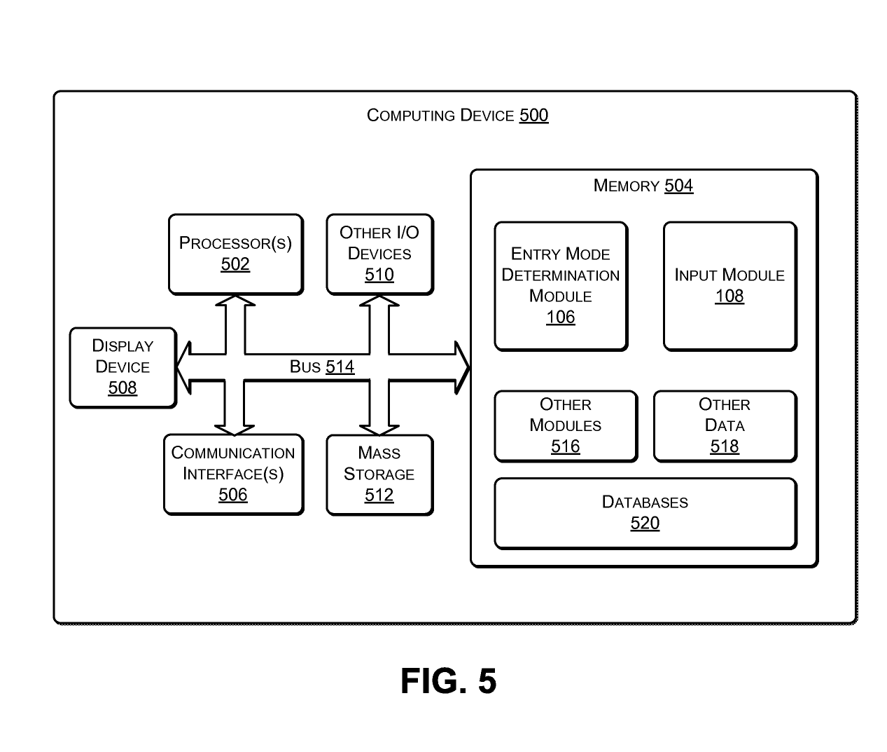

FIG. 5 illustrates an example configuration of a computing device 500 and an environment that can be used to implement the modules and functions described herein. The computing device 500 may include at least one processor 502, a memory 504, communication interfaces 506, a display device 508 (e.g. touchscreen display 104 or display 400), other input/output (I/O) devices 510 (e.g. touchscreen display 104 or a mouse and keyboard), and one or more mass storage devices 512, able to communicate with each other, such as via a system bus 514 or other suitable connection.

The processor 502 may be a single processing unit or a number of processing units, all of which may include single or multiple computing units or multiple cores. The processor 502 can be implemented as one or more microprocessors, microcomputers, microcontrollers, digital signal processors, central processing units, state machines, logic circuitries, and/or any devices that manipulate signals based on operational instructions. Among other capabilities, the processor 502 can be configured to fetch and execute computer-readable instructions stored in the memory 504, mass storage devices 512, or other computer-readable media.

Memory 504 and mass storage devices 512 are examples of computer storage media for storing instructions which are executed by the processor 502 to perform the various functions described above. For example, memory 504 may generally include both volatile memory and non-volatile memory (e.g., RAM, ROM, or the like). Further, mass storage devices 512 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 504 and mass storage devices 512 may be collectively referred to as memory or computer storage media herein, and may be a non-transitory media capable of storing computer-readable, processor-executable program instructions as computer program code that can be executed by the processor 502 as a particular machine configured for carrying out the operations and functions described in the implementations herein.

The computing device 500 may also include one or more communication interfaces 506 for exchanging data with other devices, such as via a network, direct connection, or the like, as discussed above. The communication interfaces 506 can facilitate communications within a wide variety of networks and protocol types, including wired networks (e.g., LAN, cable, etc.) and wireless networks (e.g., WLAN, cellular, satellite, etc.), the Internet and the like. Communication interfaces 506 can also provide communication with external storage (not shown), such as in a storage array, network attached storage, storage area network, or the like.

A display device 508, such as touchscreen display 104, display 400, or other display device may be included in some implementations. Other I/O devices 510 may be devices that receive various inputs from a user and provide various outputs to the user, and may include a touchscreen, such as touchscreen display 104, a keyboard, a remote controller, a mouse, a printer, audio input/output devices, and so forth.

Memory 504 may include modules and components for the computing device 102 according to the implementations discussed herein. In the illustrated example, memory 504 includes the entry mode determination module 106 that determines an entry mode for a text entry area from the input that activates the text entry area and the input module 108 as described above that affords the text entry mode selection functionality described herein. Memory 504 may further include one or more other modules 516, such as an operating system, drivers, application software, communication software, or the like. Memory 504 may also include other data 518, such as data stored while performing the functions described above and data used by the other modules 516. Memory 504 may also include other data and data structures described or alluded to herein. For example, memory 504 may include language information that is used in the course of accepting entry of text data according to a language associated with a particular entry mode that has been activated as described above.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated in FIG. 5 as being stored in memory 504 of computing device 500, entry mode determination module 106 and the input module 108, or portions thereof, may be implemented using any form of computer-readable media that is accessible by computing device 500. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A computing system comprising:
a display;
one or more processors;
one or more computer storage media storing instructions that, when executed by the one or more processors, cause the one or more processors to perform acts comprising:
displaying a text entry area in a graphical user interface on the display, the text entry area having a plurality of associated activation areas, each activation area associated with a respective entry mode of a plurality of entry modes, at least two of the activation areas associated with different entry modes of the plurality of entry modes;
receiving an input command to activate the text entry area for text entry, the input command being associated with one of the plurality of activation areas; and
activating the text entry area for text entry in the entry mode that is associated with the activation area with which the input command is associated.

2. The computing system of claim 1, wherein a first entry mode of the plurality of entry modes includes a left to right text entry direction, a second entry mode of the plurality of entry modes includes a right to left text entry direction, a first activation area of the plurality of activation areas is associated with the first entry mode, a second activation area of the plurality of activation areas is associated with the second entry mode, the first activation area being located in a left side portion of the text entry area, and the second activation area being located in a right side portion of the text entry area.

3. The computing system of claim 1, wherein an operating system stored in the one or more computer storage media comprises at least a portion of the instructions for performing the displaying, receiving and activating.

4. The computing system of claim 1, wherein the display is a touchscreen display and the input command is a touch input to the touchscreen.

5. The computing system of claim 4, the acts further comprising:
determining the activation area with which the input command is associated, the activation area with which the input command is associated determined to be the activation area located at a detected position of the touch input.

6. The computing system of claim 1, the computing system further comprising:
an input device for manipulating a cursor displayed on the display; and
wherein the input command is an input from the input device while the cursor is displayed over the text entry area.

7. The computing system of claim 6, the acts further comprising:
determining the activation area with which the input command is associated, the activation area with which the input command is associated determined to be the activation area which the cursor is displayed over when the input command is received.

8. One or more computer storage media encoded with instructions that, when executed by one or more processors, cause the one or more processors to perform acts comprising:
displaying at least one text entry area in a graphical user interface, each text entry area having at least one associated activation area and a first text entry area having a plurality of associated activation areas, each of the plurality of associated activation areas corresponding to a respective text entry mode of the first text entry area;
receiving a first input located in one of the plurality of associated activation areas of the first text entry area; and
activating the first text entry area in the text entry mode corresponding to the activation area in which the first input is located.

9. The one or more computer storage media of claim 8, wherein a first entry mode corresponding to a first associated activation area of the first text entry area includes a left to right text entry direction, a second entry mode corresponding to a second associated activation area of the first text entry area includes a right to left text entry direction.

10. The one or more computer storage media of claim 9, the first associated activation area being located in a left side portion of the first text entry area, and the second associated activation area being located in a right side portion of the first text entry area.

11. The one or more computer storage media of claim 8, wherein a second text entry area of the at least one text entry areas has a plurality of associated activation areas and each of the plurality of associated activation areas of the second text entry area corresponds to a respective text entry mode of the second text entry area; and
the acts further comprising:
receiving a second input located in an activation area of the plurality of associated activation areas of the second text entry area; and
activating the second text entry area in the text entry mode corresponding to the activation area in which the second input is located.

12. The one or more computer storage media of claim 11, wherein a number of activation areas associated with the first text entry area is different from a number of activation areas associated with the second text entry area.

13. The one or more computer storage media of claim 8, wherein an operating system stored in the one or more computer storage media comprises at least a portion of the instructions for performing the displaying, receiving and activating.

14. A computer implemented method comprising:
under the control of one or more computer systems comprising one or more processors and at least one memory, the memory storing executable instructions,
receiving an input command to activate text entry, the input command being one of a plurality of activation commands for text entry, each of the plurality of activation commands corresponding to a respective text entry mode; and
activating the text entry in the text entry mode that is associated with the input command.

15. The computer implemented method of claim 14, wherein the text entry is text entry into a text entry area of a graphical user interface, each of the plurality of activation commands corresponding to a respective text entry mode of the text entry area.

16. The computer implemented method of claim 15, wherein at least one of the plurality of activation commands is a selection input located in an area of the graphical user interface associated with that activation command.

17. The computer implemented method of claim 16, wherein an area associated with a first activation command is located in a left side portion of the text entry area and an area associated with a second activation command is located in a right side portion of the text entry area.

18. The computer implemented method of claim 15, wherein at least one of the plurality of activation commands is a combination input.

19. The computer implemented method of claim 15, wherein a first text entry mode corresponding to a first activation command includes a left to right text entry direction and a second text entry mode corresponding to a second activation command includes a right to left text entry direction.

20. The system of claim 14, wherein the text entry is text entry into one of a plurality text entry areas of a graphical user interface, each of the plurality of activations commands corresponding to a respective text entry mode of one of the text entry areas, each text entry area having at least one associated activation command, and at least two activation commands being associated with a same text entry area.
